(19) United States
(12) Patent Application Publication
(10) Pub. No.: US 2013/0010614 A1
(43) Pub. Date: Jan. 10, 2013

(54) METHOD AND APPARATUS FOR PROCESSING PACKETS IN IPv6 NETWORK

(76) Inventors: Tao Lin, Beijing (CN); Jianfeng Liu, Beijing (CN)

(21) Appl. No.: 13/387,319

(22) PCT Filed: Mar. 29, 2011
(86) PCT No.: PCT/CN11/72253

§ 371 Date: Jan. 26, 2012

(30) Foreign Application Priority Data
Mar. 29, 2010 (CN) 201010136590.2

(51) Int. Cl. H04L 12/56; H04L 12/26

(52) U.S. Cl. 370/250; 370/392

(57) ABSTRACT

Disclosed is a method and apparatus for processing packets in an IPv6 network. A CPE (Customer-Premises Equipment) replaces source address information in an IP packet with external address information after receiving the IP packet from a user terminal, stores a mapping relation between the source address information and the external address information; converts the IP packet into an IPv6 packet, and transmits the IPv6 packet to an NPE (Network-Premises Equipment) via an IPv6 tunnel between the CPE and the NPE; receives a second IP packet from the NPE via the IPv6 tunnel, converts the second IP packet according to destination address information in the second IP packet, replaces the destination address information in the converted second IP packet with the source address information corresponding to the destination address information in the mapping relation, and transmits the second IP packet to the user terminal.

### BACKGROUND ART

IPv6 is a new generation of IP protocol designed by IETF (Internet Engineering Task Force) as a successor of current IPv4 to deal with the IPv4 address exhaustion. But switching from IPv4 to IPv6 may be a difficult and long process, thus IPv4 and IPv6 will co-exist for a long time and have the need to intercommunicate with each other. The backbone network and MAN (Metropolitan Area Network) consume only a small amount of IPv4 addresses, and most IPv4 addresses are consumed by user terminals in access networks. To deal with the imminent IPv4 address exhaustion, access networks may provide IPv6 access service, i.e., the access networks adopt IPv6 protocol, and IPv6 addresses will be assigned to user terminals.

When a user terminal connected to an IPv6 network needs to visit a site in an IPv4 network, the operator should provide forwarding services. As shown in FIG. 1, according to a current solution, an edge device between the IPv4 network and the IPv6 network (i.e., the NPE (Network-Premises Equipment) shown in FIG. 1) implements functions of NAT-PT (Network Address Translation-Protocol Translation) to convert IPv6 packets from the IPv6 network into IPv4 packets according to a mapping relation between IPv4 addresses and IPv6 addresses, and to convert IPv4 packets from the IPv4 network into IPv6 packets. Thus, user terminals in the IPv6 network can thus visit sites in the IPv4 network. The mapping relation may be established in a static mapping manner or a dynamic mapping manner.

When there is a user terminal on the customer side which supports only IPv4, however, the IPv4 packet sent by the user terminal can not be transmitted in the IPv6 access network, thus the user terminal can not visit sites in the network via the IPv6 access network.

### BRIEF DESCRIPTION OF THE DRAWINGS

FIG. 1 is a schematic illustrating a network structure when IPv6 network and IPv4 network co-exist.

FIG. 2 is a flowchart illustrating a general method provided by an example.

FIG. 3 is a flowchart illustrating a detailed method provided by an example.

FIG. 4 is a schematic illustrating a network structure provided by an example.

FIG. 5 is a schematic illustrating a structure of a CPE (Customer-Premises Equipment) provided by an example.

FIG. 6 is a schematic illustrating a structure of a NPE provided by an example.

### DETAILED DESCRIPTION OF EXAMPLES

A detailed description of examples is hereinafter given with reference to specific implementations and the accompanying drawings.

The method mainly includes:

after receiving an IP packet from a user terminal, a CPE (Customer-Premises Equipment) replaces source address information in the IP packet with external address information, and stores a mapping relation between the source address information and the external address information;

the CPE converts the IP packet into an IPv6 packet, and transmits the IPv6 packet to an NPE via an IPv6 tunnel between the CPE and the NPE;

the CPE receives a second IP packet from the NPE via the IPv6 tunnel, converts the second IP packet according to destination address information in the second IP packet, replaces the destination address information in the converted second IP packet with the source address information corresponding to the destination address information in the mapping relation, and transmits the second IP packet to the user terminal.

The methods of converting the IP packet into an IPv6 packet may include IPv6 encapsulation or protocol translation, and which of the methods will be used depends on the protocol version adopted by the user terminal and the protocol version adopted by the site to be visited. Specifically, the CPE may judge whether the destination address information in the IP packet is IPv4 address information. When the destination address information is IPv4 address information, the CPE encapsulates the IP packet into an IPv6 packet before transmitting the IP packet to the NPE; and after receiving the second IP packet from the NPE, the CPE performs IPv6 decapsulation on the second IP packet. When the destination address information is IPv4 address information, the CPE may further judge whether the source address information in the IP packet is IPv6 address information. If the source address information is IPv6 address information, the CPE performs protocol translation on the IP packet to convert the IP packet into an IPv4 packet before encapsulating the IP packet into the IPv6 packet; and after decapsulating the second IP packet, the CPE further performs protocol translation to convert the second IP packet into an IPv6 packet. The CPE may also judge whether the source address information of the IP packet is IPv4 address information and whether the destination address information of the IP packet is IPv6 address information. When the source address information of the IP packet is IPv4 address information and the destination address information of the IP packet is IPv6 address information, the CPE performs protocol translation to convert the IP packet into an IPv6 packet; and after receiving the second IP packet, the CPE performs protocol translation to convert the second IP packet into an IPv4 packet.

The above second IP packet is received by the CPE from the NPE, and the destination of the second IP packet is one of the user terminals connected to the CPE. In some examples, the second IP packet may be a response packet to the IP packet sent by the user terminal.

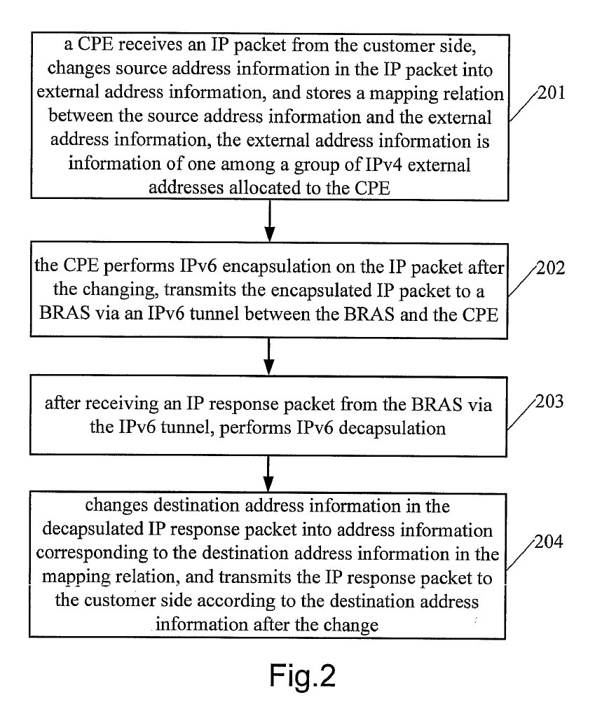

An exemplary method is illustrated in FIG. 2, mainly including the following steps.

Step 201, a CPE receives an IP packet from a user terminal, changes source address information in the IP packet into external address information, and stores a mapping relation between the source address information and the external address information. The external address information is information of one of a group of IPv4 external addresses allocated to the CPE.

Step 202, the CPE performs IPv6 encapsulation on the IP packet whose sources address information have been changed, and transmits the encapsulated IP packet to an NPE via an IPv6 tunnel between the CPE and the NPE.

Step 203, after receiving an IP response packet from the NPE via the IPv6 tunnel, the CPE performs IPv6 decapsulation on the IP response packet.

Step 204, the CPE changes destination address information in the decapsulated IP response packet into address information corresponding to the destination address information in the mapping relation, and transmits the IP response packet to the user terminal according to the destination address information of the IP response packet after the change.

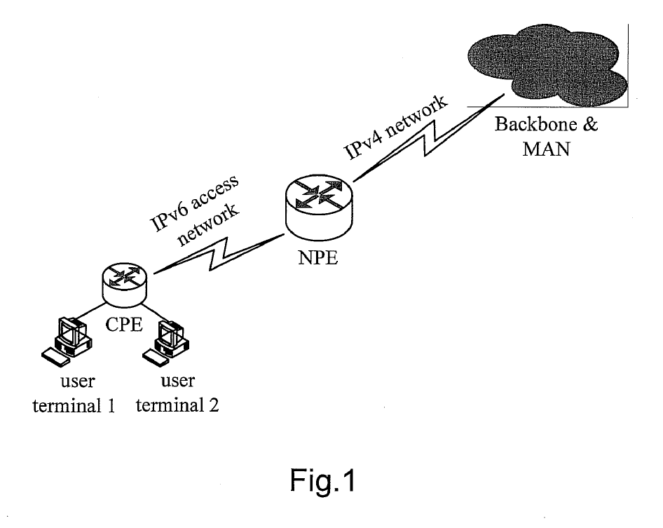

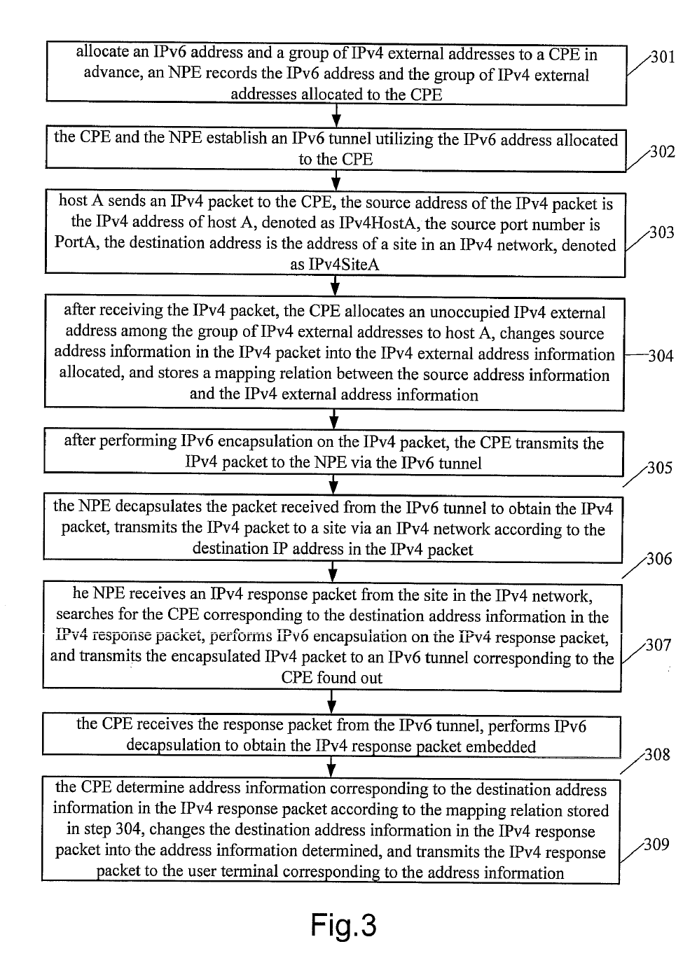

The method will be described in detail with reference to a few examples. Taking the network structure shown in FIG. 1 as an example, suppose that user terminal 1 is host A which supports only IPv4 and wants to visit a site in the IPv4 network. FIG. 3 is a flowchart illustrating a detailed method provided by an example. As shown in FIG. 3, the method may include the following steps.

Step 301, an IPv6 address and a group of IPv4 external addresses are allocated to a CPE in advance, and an NPE records the IPv6 address and the group of IPv4 external addresses allocated to the CPE.

The group of IPv4 external addresses is for: 1) forming one or more policy routes leading to the CPE at the NPE; 2) use by the CPE when changing private address information of each host on the customer side into external address information. Details will be explained in subsequent descriptions.

The IPv6 address is for use in establishing the IPv6 tunnel between the CPE and the NPE.

The IPv6 address and the group of IPv4 external addresses may be allocated to the CPE in a static configuration manner, i.e., by manually configuring the IPv6 address and the group of IPv4 external addresses for the CPE at the NPE. Or, the IPv6 address and the group of IPv4 external addresses may be allocated in a dynamic configuration manner, such as DHCP (Dynamic Host Configuration Protocol), ND (Neighbor Discovery), or Radius (Remote Authentication Dial In User Service). The following description takes DHCP dynamic configuration as an example.

When DHCP dynamic configuration is adopted, a DHCPv6 server and a DHCPv4 server may be embedded in the NPE, or be set at the side of the NPE. As an alternative, functions of the DHCPv6 server and the DHCPv4 server may also be implemented by one server. The following description is based on a most common situation where the DHCPv6 server and the DHCPv4 server are individual devices and are set at the side of the NPE. The CPE transmits a DHCP request to the DHCPv4 server and the DHCPv6 server via a BRAS (Broadband Remote Access Server), and the NPE monitors the process of allocating the IPv6 address and the group of IPv4 addresses to the CPE.

After receiving the DHCP request, the DHCPv4 server allocates a group of IPv4 external addresses to the CPE, and returns the group of IPv4 external addresses to the CPE via a DHCP response. After receiving the DHCP request, the DHCPv6 server allocates an IPv6 address to the CPE, and returns the IPv6 address to the CPE via a DHCP response.

The above-mentioned group of IPv4 external addresses may be in the form of “an IPv4 address+a port number range”, which enables multiple CPEs to share one IPv4 address, and the multiple CPEs can be differentiated from each other by different port number ranges. For example, when an NPE communicates with multiple CPEs, the multiple CPEs may be allocated with the same IPv4 address. Supposing the IPv4 address allocated to the CPEs is 2.2.2.2, the CPEs may be allocated with different port number ranges, such as, allocating port numbers 0-1023 to one CPE, and port numbers 1024-2047 to another CPE.

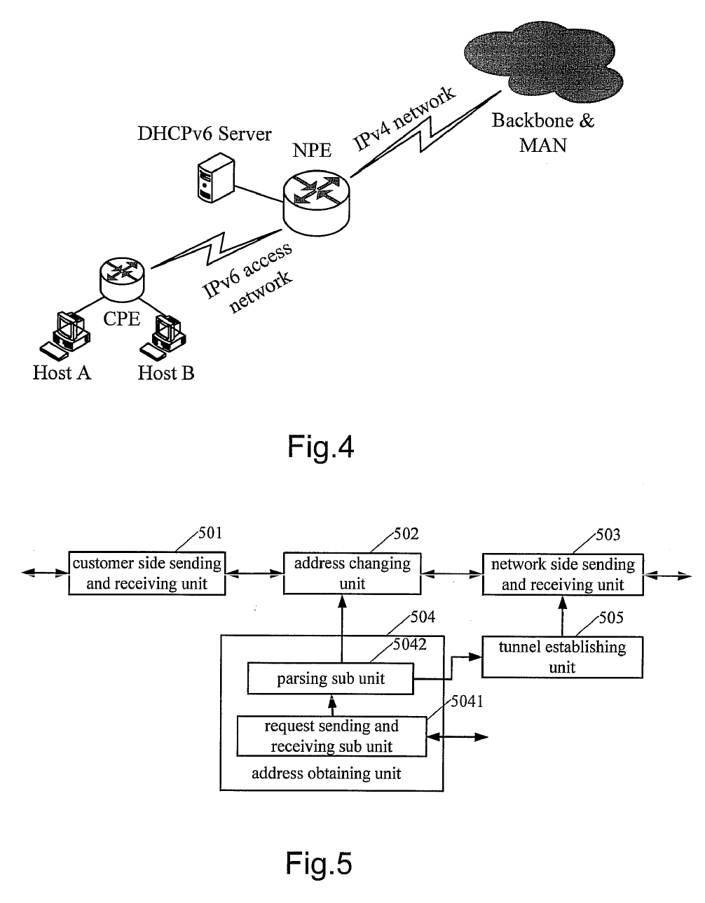

Since the CPE resides in an IPv6 network, packets transmitted or received needs to be supported by IPv6 protocol. In the above process, extra protocol should be defined for the DHCPv4 server to allocate the group of IPv4 addresses to the CPE. In order to be accommodated by current protocols without extra protocols defined, the IPv6 address and the group of IPv4 external addresses may also be allocated by the DHCPv6 server. As shown in FIG. 4, the DHCPv6 server may be set at the side of the NPE, or be embedded in the NPE.

In this situation, the DHCPv6 server may embed the group of IPv4 external addresses into the IPv6 address. Specifically, the IPv6 address may include information of the group of IPv4 external addresses and pre-defined prefix information. For example, the IPv6 address allocated to the CPE may be in the form of “pre-defined prefix information+IPv4 address+port number range”. The pre-defined prefix information may have 48 bits to 96 bits, the IPv4 address has 32 bits, and the port number range may have 0 to 16 bits.

According to an exemplary port number range, 16 bits are used for indicating the port number range, 0000000100000000 indicates that port numbers falling into a range of 8 bits from 256 are allocated to the CPE, and 0000001000000000 indicates that port numbers falling into a range of 8 bits from 512 are allocated to the CPE. Besides, other manners for embedding the IPv4 external addresses can also be adopted, and will not be elaborated herein.

In addition, the IPv6 address allocated to the CPE may be detailed information of an IPv6 address or only the prefix of the IPv6 address. In the latter situation, the CPE may generate the IPv6 address information according to the prefix.

The NPE monitors the IPv6 address and the group of IPv4 external addresses allocated by the DHCPv6 server to the CPE, obtains the IPv6 address allocated to the CPE from the IPv6 response, and obtains the group of IPv4 external addresses from the IPv6 address, and records the IPv6 address and the group of IPv4 addresses. After receiving the DHCPv6 response, the CPE obtains the IPv6 address from the DHCPv6 response, and obtains the group of IPv4 external addresses by parsing the IPv6 address.

The NPE takes the IPv6 address allocated to the CPE as the ingress of the tunnel between the CPE and the NPE, and generates policy routes leading to the CPE utilizing the group of IPv4 external addresses for forwarding IP response packets.

Step 302, the CPE and the NPE establish an IPv6 tunnel utilizing the IPv6 address allocated to the CPE.

The IPv6 tunnel adopts IPv6 protocol for transporting IPv4 packets. The addresses of the two ends of the tunnel are the IPv6 address of the CPE and the IPv6 address of the NPE.

The above steps 301 and 302 are implemented in advance during construction of the network. When host A (as shown in FIG. 2) supporting only IPv4 in the IPv6 network wants to visit a site in the IPv4 network, the following steps will be carried out.

Step 303, host A transmits an IPv4 packet to the CPE. The source IP address of the IPv4 packet is the IPv4 address of host A, denoted by IPv4 Host A, the source port number is Port A, the destination IP address is the address of the site in the IPv4 network, denoted as IPv4 Site A.

Step 304, after receiving the IPv4 packet, the CPE allocates an unoccupied IPv4 external address among the group of IPv4 external addresses of the CPE to host A, changes the source address information in the IPv4 packet into the IPv4 external address information allocated to host A, and stores a mapping relation between the source address information and the IPv4 external address information.

The IPv4 external address information allocated to host A includes an IPv4 address and a port number. Supposing the IPv4 external address information allocated to host A is 2.2.2.2+1024, the source IP address of the IPv4 packet will be changed into 2.2.2.2, and the source port number of the IPv4 packet will be changed into 1024.

Step 305, the CPE performs IPv6 encapsulation on the IP packet whose source address information is changed, and transmits the encapsulated IP packet to the NPE via the IPv6 tunnel between the CPE and the NPE.

During the IPv6 encapsulation, the source IP address in the header of the IPv6 packet in which the IPv4 packet is encapsulated is the IPv6 address of the CPE, the destination IP address being the IPv6 address of the NPE.

Step 306, the NPE performs IPv6 decapsulation on the packet received to obtain the IPv4 packet, and transmits the IPv4 packet to the site via an IPv4 network according to the destination IP address in the IPv4 packet.

Thus, the IPv4 packet of host A is transported through the IPv6 network and the IPv4 network to the destination site. For an IPv4 packet which is a response by the site, the destination address is the IPv4 external address information allocated to host A, i.e., 2.2.2.2+1024, and the following steps will be performed.

Step 307, the NPE receives the IPv4 packet which is a response from the IPv4 site, finds out the CPE corresponding to the destination address information in the IPv4 packet, encapsulates the IPv4 packet into an IPv6 packet, and transmits the IPv6 packet via the IPv6 tunnel corresponding to the CPE found.

After receiving the IPv4 packet responded by the IPv4 site, the NPE may query the policy routes, finds a match for the destination address information in the IPv4 packet, and thus finds out the CPE corresponding to the destination address information.

In step 301, the NPE has recorded the group of IPv4 external addresses allocated to each CPE, so the record can be used for determining the CPE corresponding to a group including the destination address information in the IPv4 packet received. For example, when the destination address information in the IPv4 packet received is 2.2.2.2+1024 which belongs to the group of 2.2.2.2+1024-2047, the CPE can be found out based on the group.

In step 301, the NPE has also recorded the IPv6 address allocated to each CPE, therefore, after finding out the CPE, the NPE may encapsulate the IPv4 packet into an IPv6 packet utilizing the IPv6 address of the CPE. In the header of the IPv6 packet in which the IPv4 packet is encapsulated, the source address is the IPv6 address of the NPE, and the destination address is the IPv6 address of the CPE.

Step 308, after receiving the packet from the IPv6 tunnel, the CPE performs IPv6 decapsulation on the packet to obtain the IPv4 packet encapsulated in the IPv6 packet.

Step 309, the CPE determines address information corresponding to the destination address information in the IPv4 packet, changes the destination address information in the IPv4 packet into the address information determined, and transmits the IPv4 packet to the user terminal corresponding to the address information.

Since the mapping relation between the private address information and the external address information is established in step 304 and the destination address information in the downlink IPv4 packet received by the CPE is the external address information, the CPE may translate the destination address information in the IPv4 packet according to the mapping relation and obtain the private address information of the user terminal. For example, the IPv4 destination address information is 2.2.2.2+1024, after searching in the mapping relation, the private address information corresponding to the destination address information can be determined to be IPv4 Host A+Port A, thus the IPV4 packet will be transmitted to host A according to the private address information.

In addition, it should be noted that since the address information involved in the recording and changing are all in the form of “IP address+port number” in the examples, even if two host in different private networks of different CPEs are configured with the same IP address, the two hosts will not interfere with each other in visiting external network because they are mapped to different “IPv4 public address+port number”. In some examples, the IPv4 public address is also referred to as the IPv4 external address. For example, supposing a private network of CPE 1 has host A, a private network of CPE 2 has host B, the IPv4 address configuration of host B is identical with that of host A, but host A and host B will be allocated with different external address information among the group of external addresses after the private address information is changed into public address information, i.e., with different port numbers. Thus, different mapping relations will be established for differentiating host A and host B. Transportation of packets of host B is the same with that of host A, and thus will not be repeated herein.

Through the above examples, a user terminal supporting IPv4 in an IPv6 network is able to visit an IPv4 network.

Another example also enables a user terminal supporting IPv6 in an IPv6 network to visit an IPv4 network. The process of a user terminal supporting IPv6 visiting an IPv4 network is similar with that shown in FIG. 3. The differences lie in that: since the packet sent by the user terminal supporting IPv6 is an IPv6 packet whose source address information is “IPv6 address+port number”, when changing the source address information in step 304, the CPE will allocate an unoccupied IPv4 external address information to the user terminal, and change the source address information of the IPv6 packet into the IPv4 external address information allocated. The mapping relation stored is a relation between “IPv6 address+port number” and “IPv4 address+port number”. Then, in order to make the packet suitable for being transported in the IPv4 network, the CPE will perform protocol translation on the IPv6 packet to convert the IPv6 packet into an IPv4 packet, and then encapsulate the IPv4 packet into an IPv6 packet. Accordingly, for a response packet, the CPE decapsulates the packet to obtain an IPv4 packet and changes the destination address information of the IPv4 packet in step 309, the destination address information after the change is “IPv6 address+port”. Then, the CPE will perform protocol translation to convert the IPv4 packet into an IPv6 packet before transmitting the response packet to the user terminal.

When the NPE is a dual-stack device, i.e., the network side of the NPE may be an IPv4 network or an IPv6 network, a user terminal in an IPv6 network may choose to visit an IPv6 network. When a user terminal supporting IPv4 wants to visit a site in an IPv6 network, the CPE is allocated with multiple IPv6 public addresses, which may be in the form of a range of IPv6 public addresses or in the form of a pool of IPv6 public addresses. When the user terminal supporting IPv4 needs to visit a site in an IPv6 network, the packet sent by the user terminal is an IPv4 packet, the CPE receives the IPv4 packet, and changes the source IP address information in the IPv4 packet into IPv6 public address information, and records information of the source IP address information and the IPv6 public address information. The IPv6 public address information is one among the multiple IPv6 public addresses allocated to the CPE. Then, the CPE needs to perform protocol translation to convert the IPv4 packet into an IPv6 packet and transmit the IPv6 packet to the NPE via the IPv6 tunnel.

After the above address changing and protocol conversion, since the access network and the public network are both IPv6 network, the converted IP packet can be directly transmitted to the NPE and be forwarded by the NPE to an external network. For an IP response packet, the CPE changes the destination address in the IP response packet according to recorded source IP address information and the IPv6 public address information, and the destination IP address is changed into an IPv4 address. Then the CPE performs protocol translation to convert the IPv6 response packet into an IPv4 response packet, and transmits the IPv4 response packet to the user terminal corresponding to the IPv4 address, thus implements the packet interchanging process. The above source address information may be an IPv4 address, or in the form of “IPv4 address+port number”; the corresponding IPv6 public address information may be an IPv6 address or in the form of “IPv6 address+port number”.

The above is the detailed description of the method provided by the examples. The following will describe the system and apparatus provided by examples in detail. The system provide by an example may be as shown in FIG. 4, which mainly includes: a CPE and an NPE.

The CPE is for receiving an IP packet from a user terminal, changing source address information in the IP packet into external address information, and storing a mapping relation between the source address information and the external address information, where the external address information is information of one among a group of IPv4 external addresses allocated to the CPE; performing IPv6 encapsulation on the IP packet whose source address information has been changed, transmitting the encapsulated IP packet to the NPE via an IPv6 tunnel between the CPE and the NPE; receiving an IP response packet from the NPE via the IPv6 tunnel, performing IPv6 decapsulation on the IP response packet; changing destination address information in the IP response packet decapsulated into address information corresponding to the destination address information in the mapping relation, and transmitting the IP response packet to the user terminal corresponding to the destination address information after the change.

The NPE is for receiving the IP packet via the IPv6 tunnel between the CPE and the NPE, performing IPv6 decapsulation on the IP packet, transmitting the decapsulated IP packet to an IPv4 network; receiving the IP response packet from the IPv4 network, determining the CPE which is corresponding to the destination address information in the IP response packet according to recorded IPv4 external address information allocated to each CPE, performing IPv6 encapsulation on the IP response packet and transmitting the encapsulated IP response packet via the IPv6 tunnel corresponding to the CPE determined.

In addition, the IPv6 address and the group of IPv4 external addresses may be configured in a static manner or in a dynamic manner. If a dynamic manner is adopted, the system may further include: an IPv6 address allocating unit, for receiving an IPv6 address allocation request sent by the CPE via the NPE, allocating an IPv6 address to the CPE, and transmitting the IPv6 address to the CPE via the NPE. The IPv6 address consists of information of the group of IPv4 external addresses and pre-defined prefix information.

The NPE is further for monitoring and recording the IPv6 address and the group of IPv4 external addresses allocated by the IPv6 address allocation unit.

The IPv6 address allocation unit may be a DHCPv6 server or any other network device which equips with the functions of allocating IPv6 addresses.

FIG. 5 is a schematic illustrating a structure of a CPE provided by an example. As shown in FIG. 5, the CPE may include: a customer side sending and receiving unit 501, an address changing unit 502 and a network side sending and receiving unit 503.

The customer side sending and receiving unit 501 is for receiving an IP packet from a user terminal, sending the IP packet to the address changing unit 502; sending an IP response packet sent by the address changing unit 502 to a user terminal according to destination address information.

The address changing unit 502 is for changing source address information in the IP packet into external address information, and sending the IP packet after the changing to the network side sending and receiving unit 503, and storing a mapping relation between the source address information and the external address information; changing destination address information in the IP response packet sent by the network side sending and receiving unit 503 into address information corresponding to the destination address information in the mapping relation, and sending the IP response packet after the changing to the customer side sending and receiving unit 501. The external address information is one among the group of IPv4 external addresses allocated to the CPE.

The network side sending and receiving unit 503 is for converting the IP packet sent by the address changing unit 502 into an IPv6 packet, transmitting the IPv6 packet to an NPE via an IPv6 tunnel between the CPE and the NPE; receiving the IP response packet from the NPE via the IPv6 tunnel, converting the IP response packet according to the destination address information in the IP response packet, and sending the IP response packet after the conversion to the address changing unit 502.

Specifically, the network side sending and receiving unit 503 may be for judging whether the destination address information in the IP packet is IPv4 address information; when the destination address information in the IP packet is IPv4 address information, performing IPv6 encapsulation on the IP packet before sending the IP packet to the NPE; after receiving the IP response packet, performing IPv6 decapsulation on the IP response packet, and sending the decapsulated IP response packet to the address changing unit 502. The network side sending and receiving unit 503 may also judge whether source address information in the IP packet is IPv6 address information, if the source address information in the IP packet is IPv6 address information, perform protocol translation to convert the IP packet into an IPv4 packet before encapsulating the IP packet into an IPv6 packet; after receiving the IP response packet, perform protocol translation to convert the IP response packet into an IPv6 packet, and send the IPv6 packet to the address changing unit 502.

The network side sending and receiving unit 503 may also judge whether the source address information of the IP packet is IPv4 address information and whether the destination address information is IPv6 address information, if the source address information is IPv4 address information and the destination address information is IPv6 address information, perform protocol translation to convert the IP packet into an IPv6 packet before transmitting the IP packet to the NPE; and after receiving the IP response packet, perform protocol translation to convert the IP response packet into an IPv4 packet and send the IPv4 packet to the address changing unit 502.

For example, the network side sending and receiving unit 503 may encapsulate the IP packet sent by the address changing unit 502 into an IPv6 packet, and transmit the IPv6 packet to the NPE via the IPv6 tunnel between the CPE and the NPE; receive the IP response packet from the NPE via the IPv6 tunnel, perform IPv6 decapsulation on the IP response packet, and send the IP response packet to the address changing unit 502.

The CPE may further include: an address obtaining unit 504 and a tunnel establishing unit 505.

The address obtaining unit 504 is for obtain the IPv6 address and the group of IPv4 external addresses allocated to the CPE.

The tunnel establishing unit 505 is for establishing the IPv6 tunnel with the NPE utilizing the IPv6 address allocated to the CPE.

When a dynamic configuration manner is adopted, the address obtaining unit 504 may include: a request sending and receiving sub unit 5041 and a parsing sub unit 5042.

The request sending and receiving sub unit 5041 is for request allocation of an IPv6 address via the NPE; receive the IPv6 address allocated to the CPE via the NPE, and send the IPv6 address to the parsing sub unit 5042.

The parsing sub unit 5042 is for parsing the IPv6 address to obtain the group of IPv4 external addresses allocated to the CPE. The IPv6 address includes information of the group of IPv4 external addresses allocated to the CPE and a pre-defined prefix information.

The above source address information may include an IPv4 address and a port number, or an IPv6 address and a port number. The group of external addresses includes an IPv4 address and a range of port numbers. CPEs communicating with the same NPE may be allocated with the same IPv4 address and different ranges of port numbers. The external address information includes an IPv4 address and a port number.

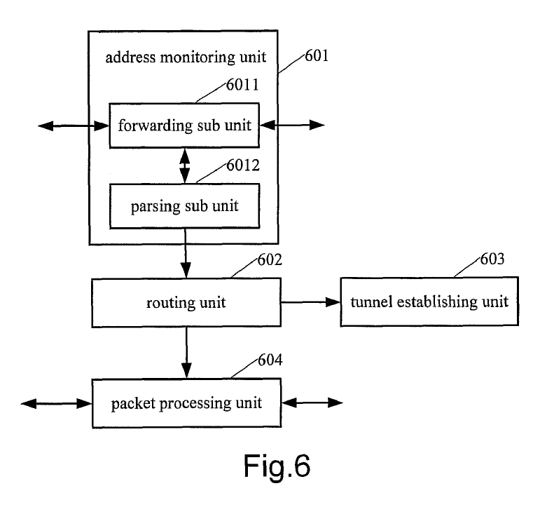

FIG. 6 is a schematic illustrating a structure of an NPE provided by an example. As shown in FIG. 6, the NPE may include: an address monitoring unit 601, a routing unit 602, a tunnel establishing unit 603 and a packet processing unit 604.

The address monitoring unit 601 is for monitoring an IPv6 address and information of a group of IPv4 external addresses.

The routing unit 602 is for recording the IPv6 address and the information of the group of IPv4 external addresses.

The tunnel establishing unit 603 is for establishing an IPv6 tunnel with the CPE utilizing the IPv6 address allocated to the CPE.

The packet processing unit 604 is for receiving an IP packet via the IPv6 tunnel between the CPE and the NPE, performing IPv6 decapsulation on the IP packet, transmitting the decapsulated IP packet to an IPv4 network; receiving an IP response packet from the IPv4 network, determining the CPE which is corresponding to destination address information in the IP response packet according to recorded IPv4 external address information allocated to each CPE, performing IPv6 encapsulation on the IP response packet and transmitting the encapsulated IP response packet via the IPv6 tunnel corresponding to the CPE determined.

The routing unit 602 is for generating policy routes based on the IPv4 external address information allocated to the CPE, and the egress interface of the policy routes is the ingress interface of the IPv6 tunnel. Therefore, the packet processing unit 604 is able to transmit the IP response packet to a proper CPE by querying the policy routes.

The address monitoring unit 601 may include: a forwarding sub unit 6011 and a parsing sub unit 6012.

The forwarding sub unit 6011 is for forwarding a request sent by the CPE for IPv6 address allocation; receive and forward the IPv6 address allocated to the CPE.

The parsing sub unit 6012 is for parsing the IPv6 address allocated to the CPE received from the forwarding sub unit 6011 to obtain IPv4 external address information allocated to the CPE.

The IPv6 address may include the IPv4 external address information allocated to the CPE and pre-defined prefix information.

From the above description it can be seen that, the method, system and apparatus provided by examples have the following merits.

1) The CPE of the examples is configured to be able to change source address information in an IP packet from the customer side into external address information from among a group of IPv4 external addresses of the CPE, record the mapping relation between the source address information and the external address information, perform IPv6 encapsulation on the IP packet and transmit the encapsulated IP packet to an IPv4 network via the NPE; and perform IPv6 decapsulation on an IP response packet from the IPv4 network, change the destination address information in the IP response packet into private address information corresponding to the destination address information in the mapping relation, and transmit the changed IP response packet to the customer side. That is, examples provide a method of implementing address translation at the CPE, so that a user terminal in an IPv6 network can visit an IPv4 network no matter the user terminal supports IPv4 or IPv6. Thus, during the switching from IPv4 to IPv6, existing IPv4 hosts can be better accommodated, and costs for the switching can also be reduced. Further, NPEs does not need complex NAT configurations, thus resources consumed by the NPE are reduced.

2) According to the examples, each CPE is allocated with a group of IPv4 external addresses in the form of “IPv4 address+a range of port numbers”, thus different CPEs communicating with the same NPE can share one IPv4 address and be differentiated with each other by the different ranges of port numbers. In this way, IPv4 address resources is fully used.

3) The address information involved in the recording and changing is in the form of “IP address+port number”, user terminals belonging to different CPE and configured with the same IP address can be differentiated with each other, and thus all user terminals can run properly to visit the IPv4 network.

The foregoing are only preferred embodiments of the present invention and are not for use in limiting the protection scope thereof. All modifications, equivalent replacements or improvements in accordance with the spirit and principles of the present invention shall be included in the protection scope of the present invention.

1. A method for processing packets in an IPv6 network, applied to a CPE (Customer-Premises Equipment) which is capable of communicating with an NPE (Network-Premises Equipment), comprising:
replacing source address information in an IP packet with external address information after receiving the IP packet from a user terminal, storing a mapping relation between the source address information and the external address information;
converting the IP packet into an IPv6 packet, and transmits the IPv6 packet to an NPE via an IPv6 tunnel between the CPE and the NPE;
receiving a second IP packet from the NPE via the IPv6 tunnel, converting the second IP packet according to destination address information in the second IP packet, replacing the destination address information in the converted second IP packet with the source address information corresponding to the destination address information in the mapping relation, and transmitting the second LP packet to the user terminal.

2. A method of claim 1, further comprising:
judging whether destination address information is IPv4 address information;
wherein when the destination address information is IPv4 address information, converting the IP packet into an IPv6 packet comprises: performing IPv6 encapsulation on the IP packet before transmitting the IP packet to the NPE; converting the second IP packet according to destination address information in the second IP packet comprises: performing IPv6 decapsulation on the second IP packet after receiving the second IP packet.

3. The method of claim 2, further comprising:
judging whether the source address information is IPv6 address information when the destination address information is IPv4 address information; when the source address information is IPv6 address information, performing protocol translation on the IP packet to convert the IP packet into an IPv4 packet before performing IPv6 encapsulation on the IP packet; and after decapsulating the second IP packet, performing protocol translation to convert the second IP packet into an IPv6 packet.

4. The method of claim 1, further comprising:
judging whether the source address information of the IP packet is IPv4 address information and whether destination address information of the IP packet is IPv6 address information;
wherein when the source address information of the IP packet is IPv4 address information and the destination address information of the IP packet is IPv6 address information, converting the IP packet into an IPv6 packet comprises: performing protocol translation to convert the IP packet into an IPv6 packet; and converting the second IP packet according to destination address information in the second IP packet comprises: performing protocol translation to convert the second IP packet into an IPv4 packet after receiving the second IP packet.

5. The method of claim 2, further comprising:
establishing the IPv6 tunnel between the CPE and the NPE utilizing an IPv6 address allocated to the CPE in advance.

6. The method of claim 2, further comprising:
requesting allocation of the IPv6 address via the NPE;
receiving the IPv6 address allocated to the CPE via the NPE, obtaining IPv4 external address information allocated to the CPE by parsing the IPv6 address; wherein the IPv6 address includes the IPv4 external address information allocated to the CPE and pre-defined prefix information.

7. The method of claim 2, wherein the external address information is information of one among a group of IPv4 external addresses allocated to the CPE.

8. The method of claim 7, wherein the source address information includes an IPv4 address and a port number;
the external address information includes an IPv4 address and a port number; and
the information of the group of IPv4 external address information includes an IPv4 address and a port number range.

9. The method of claim 8, wherein different CPE are allocated with the same IPv4 address and different port number ranges.

10. The method of claim 4, wherein the external address information includes an IPv6 address and a port number.

11. A CPE (Customer-Premises Equipment), capable of communicating with an NPE (Network-Premises Equipment), comprising:
a customer side sending and receiving unit, an address changing unit and a network side sending and receiving unit;
the customer side sending and receiving unit is for receiving an IP packet from a user terminal, sending the IP packet to the address changing unit; sending a second IP packet sent by the address changing unit to a user terminal according to destination address information in the second IP packet;
the address changing unit is for replacing source address information in the 11³ packet with external address information, sending the IP packet to the network side sending and receiving unit, storing a mapping relation between the source address information and the external address information;
replacing destination address information in the second IP packet sent by the network side sending and receiving unit into the source address information corresponding to the destination address information in the mapping relation, and sending the second IP packet to the customer side sending and receiving unit; and
the network side sending and receiving unit is for converting the IP packet sent by the address changing unit into an IPv6 packet, transmitting the IPv6 packet to the NPE via an IPv6 tunnel between the CPE and the NPE; receiving the second IP packet from the NPE via the IPv6 tunnel, converting the second IP packet according to the destination address information in the second IP packet, and sending the second IP packet after the conversion to the address changing unit.

12. The CPE of claim 11, wherein
the network side sending and receiving unit is further for judging whether destination address information in the IP packet is IPv4 address information; when the destination address information is IPv4 address information, encapsulating the IP packet into an IPv6 packet before transmitting the IP packet to the NPE; and
after receiving the second IP packet, performing IPv6 decapsulation on the second IP packet.

13. The CPE of claim 12, wherein
when the destination address information in the IP packet is IPv4 address information, the CPE may further judge whether the source address information in the IP packet is IPv6 address information; when the source address information is IPv6 address information, the CPE performs protocol translation on the IP packet to convert the IP packet into an IPv4 packet before performing IPv6 encapsulation on the IP packet; and
after performing IPv6 decapsulation on the second IP packet, performing protocol translation to convert the second IP packet into an IPv6 packet.

14. The CPE of claim 11, wherein
the network side sending and receiving unit is further for judging whether the source address information of the IP packet is IPv4 address information and whether destination address information of the IP packet is IPv6 address information; when the source address information is IPv4 address information and the destination address information is IPv6 address information, performing protocol translation to convert the IP packet into an IPv6 packet before transmitting the IP packet to the NPE; and
after receiving the second IP packet, performing protocol translation to convert the second IP packet into an IPv4 packet and send the IPv4 packet to the address changing unit.

15. The CPE of claim 12, further comprising:
an address obtaining unit and a tunnel establishing unit;
the address obtaining unit is for obtaining an IPv6 address allocated to the CPE;
the tunnel establishing unit is for establishing the IPv6 tunnel utilizing the IPv6 address allocated to the CPE.

16. The CPE of claim 12, wherein the address obtaining unit comprises:
a request sending and receiving sub unit, for requesting allocation of an IPv6 address via the NPE; receiving the IPv6 address allocated to the CPE via the NPE, and sending the IPv6 address to a parsing sub unit; and
a parsing sub unit, for parsing the IPv6 address to obtain a group of IPv4 external addresses allocated to the CPE; wherein the IPv6 address includes information of the group of IPv4 external addresses allocated to the CPE and pre-defined prefix information.

17. The CPE of claim 15, wherein the address obtaining unit is further for obtaining external address information including an IPv4 address and a port number range allocated to the CPE.

18. A method for processing packets in an IPv6 network, applied to an NPE (Network-Premises Equipment) which is capable of communicating with at least one CPE (Customer-Premises Equipment), comprising:
monitoring and recording an IPv6 address and IPv4 external address information allocated to the CPE, establishing an IPv6 tunnel between the CPE and the NPE utilizing the IPv6 address allocated to the CPE;
performing IPv6 decapsulation on an IP packet received from the CPE via the IPv6 tunnel, transmitting the decapsulated IP packet to an IPv4 network;
determining the CPE corresponding to destination address information in a second IP packet received from the IPv4 network according to the recorded IPv4 external address information allocated to each CPE, performing IPv6 encapsulation on the second IP packet, and transmitting the encapsulated second IP packet via the IPv6 tunnel corresponding to the CPE determined.

19. The method of claim 18, wherein monitoring and recording the IPv6 address and the IPv4 external address information allocated to the CPE comprises:
forwarding the request for allocation of IPv6 address sent by the CPE;
receiving the IPv6 address allocated to the CPE, obtaining IPv4 external address information allocated to the CPE by parsing the IPv6 address, recording the IPv6 address and IPv4 external address information; wherein the IPv6 address includes IPv4 external address information allocated to the CPE and pre-defined prefix information.

20. An NPE (Network-Premises Equipment), capable of communicating with at least one CPE (Customer-Premises Equipment), comprising:
an address monitoring unit, a routing unit, a tunnel establishing unit and a packet processing unit;
the address monitoring unit is for monitoring an IPv6 address and IPv4 external address information allocated to a CPE;
the routing unit is for recording the IPv6 address the IPv4 external address information allocated to the CPE;
the tunnel establishing unit is for establishing an IPv6 tunnel utilizing the IPv6 address allocated to the CPE;
the packet processing unit is for receiving an IP packet via the IPv6 tunnel between the CPE and the NPE, performing IPv6 decapsulation on the IP packet, transmitting the decapsulated IP packet to an IPv4 network; receiving a second IP packet from the IPv4 network, determining a CPE which is corresponding to destination address information in the second IP packet according to recorded IPv4 external address information allocated to each CPE, performing IPv6 encapsulation on the second IP packet and transmitting the encapsulated second IP packet via an IPv6 tunnel corresponding to the CPE determined.

21. The NPE of claim 20, wherein the address monitoring unit comprises:
a forwarding sub unit and a parsing sub unit;
the forwarding sub unit is for forwarding a request sent by the CPE for IPv6 address allocation; receive and forwarding the IPv6 address allocated to the CPE;
the parsing sub unit is for parsing the IPv6 address allocated to the CPE received from the forwarding sub unit to obtain IPv4 external address information allocated to the CPE;
wherein the IPv6 address include IPv4 external address information allocated to the CPE and pre-defined prefix information.
